(19) United States
(12) Patent Application Publication
(10) Pub. No.: US 2007/0268856 A1
(43) Pub. Date: Nov. 22, 2007

(54) BEACON BROADCASTER METHODS AND SYSTEMS FOR WIRELESS NETWORKS

(75) Inventors: Carl S. Wijting, Helsinki (FI); Juha Salokannel, Tampere (FI); Jarkko Kneckt, Espoo (FI)

Correspondence Address: BRAKE HUGHES BELLERMANN LLP, c/o INTELLEVATE, P.O. BOX 52050, MINNEAPOLIS, MN, 55402, US

(73) Assignee: Nokia Corporation, Espoo (FI)

(21) Appl. No.: 11/747,513

(22) Filed: May 11, 2007

Related U.S. Application Data
(60) Provisional application No. 60/800,659, filed on May 16, 2006.

(51) Int. Cl. H04Q 7/00

(52) U.S. Cl. 370/328

(57) ABSTRACT

Various embodiments are described relating to changing the role of the beacon broadcaster among nodes in a wireless network, such as a wireless meshed network. In an example embodiment, a message, for example, a beacon message, including a connectivity report description, may be sent from a current beacon broadcaster to one or more nodes in a wireless network. A connectivity report based on the connectivity report description may be received from a reporting node included in the one or more nodes. A next beacon broadcaster may be determined based on the connectivity report received from the one or more nodes.

### CROSS-REFERENCE TO RELATED APPLICATION

This application claims priority based on U.S. Provisional Application No. 60/800,659, filed on May 16, 2006, entitled, “Beacon Broadcaster Methods and Systems for Wireless Networks,” the disclosure of which is hereby incorporated by reference.

### BACKGROUND

As wireless technology has advanced, a variety of wireless networks have been installed, such as cellular and other wireless networks. Some wireless networks are based upon the Institute of Electrical and Electronics Engineers (IEEE) 802.11 family of Wireless LAN (WLAN) industry specifications, for example. A number of working groups are working to improve on this technology.

Wireless networks may include a number of mesh points, including lightweight mesh points or other wireless nodes implementing powersave features, to support limited battery capacity of portable devices such as, for example, mobile phones, personal digital assistants, and portable computers. The limited battery capacity may thus limit the time such portable devices may remain in an active state.

Thus, one solution may include a powersave (PS) mode such that one or more stations in the network that are in PS mode may be synchronized to wake up at the same time. At this time a window may be initiated in which a sender announces buffered frames for a receiver. In order to accommodate ad-hoc networks, a Timing Synchronization Function (TSF) may be implemented with an actual power saving mechanism. A network node, for example, a beacon broadcaster, may generate beacon messages, which may include a time stamp and other synchronization information. Network nodes within a Basic Service Set (BSS) receiving the beacon message may then adjust their local timers to the time stamp included with the beacon message. Due to an absence of a trusted authority in an ad-hoc network, local timers may be adjusted in a distributed manner, for example, by allowing every node in the network to generate a beacon. After a predetermined beacon interval, for example, all nodes may compete for transmission of the beacon using a backoff algorithm. Generally, a backoff algorithm may be implemented by different nodes willing to access a common medium, with each of the different nodes, as an example, selecting a random number between 0 and a predetermined integer n, and its respective random number of slots before accessing the medium, possibly checking whether another node may have already accessed the medium before actually accessing the medium. A first node may “win” the competition to become a beacon broadcaster node, and all other nodes in the network may cancel their beacon transmission and adjust their local timers to the time stamp of the winning beacon broadcaster node.

The beacon broadcaster node may transmit together with the beacon frame, for example, a Traffic Indication Map (TIM), such that all unicast packets for network nodes in sleep state may be announced by the TIM. The nodes may then poll the beacon broadcaster for the packets. If broadcast/multicast frames are to be transmitted, they may be announced, for example, by a Delivery Traffic Indication Map (DTIM) and may be sent immediately afterwards. Network nodes in powersave mode may thus need to wake up shortly before the end of the beacon interval, and may need to stay awake until the beacon transmission has ended.

Packets for a network node in a sleep state may be buffered by a sender until the end of a beacon interval. They may be announced by Ad-hoc Traffic Indication Maps (ATIMs), which may be transmitted in an interval which may be referred to as an ATIM window directly after the beacon. ATIMs may be implemented as unicast frames which may be acknowledged by a receiver. After sending the acknowledgment, the receiver may not fall back into a sleep or doze state, but may instead remain awake to wait for the announced packet to arrive. Both ATIMs and data packets may be transmitted using a backoff algorithm.

Thus, in a meshed network, a beacon message may be broadcast periodically to transmit synchronization information so that each mesh point may know when it needs to be awake to receive messages and when it may sleep. A beacon broadcaster functionality may be implemented by any of the mesh nodes or nodes in a wireless network, and it may thus be desirable to switch the beacon broadcaster role among multiple mesh nodes in the network. By switching the beacon broadcaster functionality among multiple nodes, this may avoid one node bearing the beacon broadcaster burden, and may allow all nodes to spend some time in a low power or sleep state from time to time.

### SUMMARY

Various embodiments are described relating to changing the role of the beacon broadcaster among nodes in wireless networks.

According to an example embodiment, a message including a connectivity report description may be sent from a current beacon broadcaster to one or more nodes in a wireless network. A connectivity report based on the connectivity report description may be received from a reporting node included in the one or more nodes. A next beacon broadcaster may be determined based on the connectivity report received from the one or more nodes.

In an example embodiment, a message including a connectivity report description may be received from a current beacon broadcaster. A connectivity report may be sent to the current beacon broadcaster based on the received connectivity report description. A message may be received identifying the next beacon broadcaster from the current beacon broadcaster.

In another example embodiment, an apparatus for wireless communications may include a controller, a memory coupled to the controller, and a wireless transceiver coupled to the controller. The apparatus may be adapted to: 1) send a message including a connectivity report description from a current beacon broadcaster to one or more nodes in a wireless network; 2) receive a connectivity report based on the connectivity report description from a reporting node included in the one or more nodes; and 3) determine a next beacon broadcaster based on the connectivity report received from the one or more nodes.

### BRIEF DESCRIPTION OF THE DRAWINGS

FIG. 1 is a diagram illustrating a wireless meshed network according to an example embodiment.

FIG. 2 is a diagram of an example configuration of a wireless meshed network according to an embodiment.

FIG. 3 is a diagram illustrating operation of transmission of a report description from a current beacon broadcaster according to an example embodiment.

FIG. 4 is a flow chart illustrating operation of determining a next beacon broadcaster according to an example embodiment.

FIG. 5a is an example format of a reporting control field included in an example reporting information element format according to an example embodiment.

FIG. 5b is an example reporting information element field format according to an example embodiment.

FIG. 6a is an example format of a neighbor list element that includes an example meshed point control field format according to an example embodiment.

FIG. 6b is an example meshed point control field format according to an example embodiment.

FIG. 7 is a diagram of an example configuration of a wireless meshed network according to an embodiment.

FIG. 8a is a diagram of an example configuration of a wireless meshed network according to an embodiment.

FIG. 8b is a diagram illustrating operation of transmission of reports from wireless meshed nodes according to an example embodiment.

FIG. 9a is a diagram of an example configuration of a wireless meshed network according to an embodiment.

FIG. 9b is a diagram illustrating operation of transmission of reports from wireless meshed nodes according to an example embodiment.

FIG. 10 is a diagram illustrating operation of unicast transmission of reports from wireless meshed nodes according to an example embodiment.

FIG. 11 is a diagram of an example configuration of a wireless meshed network including a node receiving beacon messages from two beacon broadcaster nodes according to an embodiment.

FIG. 12a is a diagram of an example configuration of a wireless meshed network including a single beacon broadcaster according to an embodiment.

FIG. 12b is a diagram of an example configuration of a wireless meshed network including an assistant beacon broadcaster according to an embodiment.

FIG. 13 is a block diagram illustrating an apparatus that may be provided in a wireless station according to an example embodiment.

### DETAILED DESCRIPTION

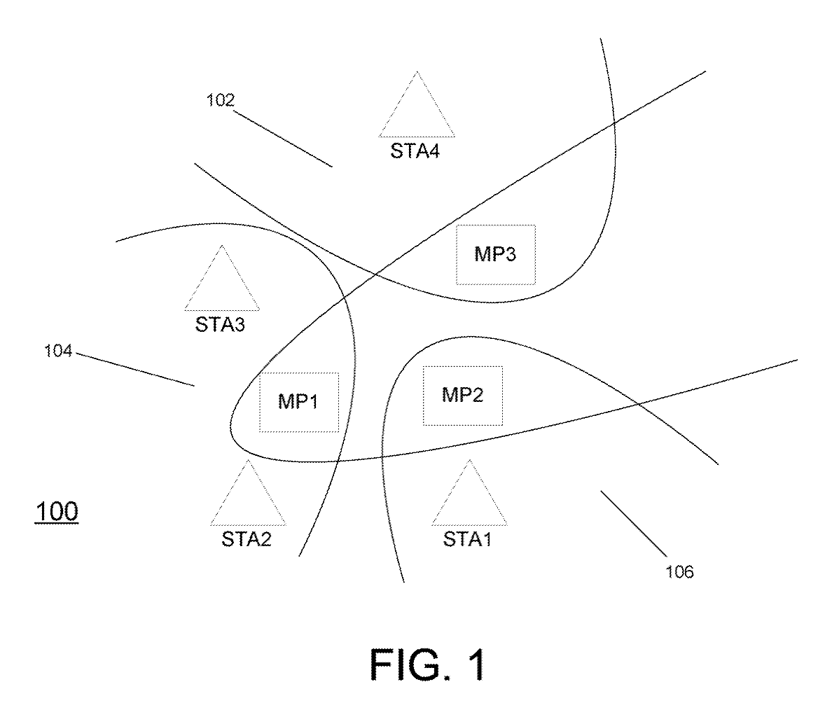

Referring to the Figures in which like numerals indicate like elements, FIG. 1 is a diagram illustrating a wireless meshed network 100 according to an example embodiment.

According to an example embodiment, a wireless meshed network may be considered to be a collection of mesh points (MPs) interconnected with wireless links. Each MP may typically be an Access Point, but may also be a station or other wireless node. For example, a wireless meshed network may employ either a full mesh topology or a partial mesh topology. In a full mesh topology, each node (or mesh point) may be connected directly to each of the other MPs via a wireless link. In a partial mesh topology, the mesh points may be connected to some but not necessarily all of the other mesh points in the meshed network.

In the example wireless meshed network 100 illustrated in FIG. 1, mesh points MP1, MP2 and MP3 may be inter-connected via wireless links. Also, each mesh point (MP) may be coupled to one or more wireless stations in its local cell. For example, MP1 is located in cell 104 and is connected via wireless links to stations STA2 and STA3 within cell 104. MP2 is located in cell 106 and is connected via wireless link to station STA1. MP3 is located in cell 102 and is connected via wireless link to station STA4. Network 100 (including MP1, MP2 and MP3) may also be considered a wireless distribution system. Wireless meshed network 100 is merely an example network and the present disclosure is not limited thereto. Various embodiments and features described herein may be applicable to a wide variety of wireless networks including WLAN networks, cellular networks and the like.

In an example wireless meshed network, each MP may be capable of many-to-many connections, and may be capable of learning network topology, dynamic path configuration, and other network capabilities, although the present disclosure is not limited thereto. Each MP may also be mobile or be capable of being moved or movable, and may be capable of dynamically reconfiguring itself, although the present disclosure is not limited thereto.

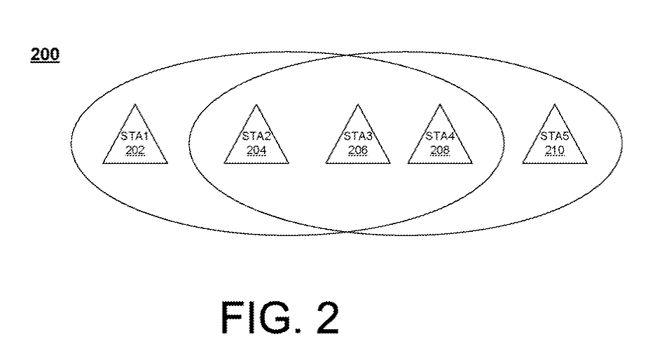

FIG. 2 is a diagram of an example configuration of a wireless meshed network 200 according to an embodiment. As shown in FIG. 2, a meshed node STA1 202 is in range of, and thus may receive messages from, meshed nodes STA2 204, STA3 206, and STA4 208. Moreover, a meshed node STA5 210 is also in range of, and may receive messages from, the meshed nodes STA2 204, STA3 206, and STA4 208. Further, each of the meshed nodes STA2 204, STA3 206, and STA4 208 are in range of each other, and may receive messages from among themselves. However, meshed nodes STA1 202 and STA5 210, as shown in FIG. 2, are not in range of each other, and thus may not receive messages from each other directly. Thus, the meshed nodes STA2 204, STA3 206, and STA4 208 may send messages to, or receive messages from, any of the meshed nodes STA1 202, STA2 204, STA3 206, STA4 208, and STA5 210. Therefore, if, for example, STA2 204 were designated a beacon broadcaster node for the example wireless meshed network 200 shown in FIG. 2, then all of the meshed nodes STA1 202, STA3 206, STA4 208, and STA5 210 may be able to receive the beacon messages sent by STA2 204, and thus, may be able to maintain synchronization for receiving messages in the network.

If a decision were made to switch the role of beacon broadcaster from STA2 204 to STA3 206 or to STA4 208, all of the meshed nodes STA1 202, STA2 204, STA3 206, STA4 208, and STA5 210 would still be in range of the new beacon broadcaster. However, if a decision were made, for example, to switch the role of beacon broadcaster from STA2 204 to STA5 210, then STA1 202 may be out of range and unable to receive the beacon messages sent by STA5 210.

Rotating the beacon broadcaster functionality among nodes may decrease the possibility that, for example, movement of nodes may cause a current broadcasting node to lose communication capabilities with one or more of the nodes that receive their beacon messages from the current beacon broadcaster. Thus, a new beacon broadcaster may be selected such that more nodes in the meshed network may receive beacon messages from the new beacon broadcaster.

As discussed below, a solution to determining a next beacon broadcaster may include, at least, one or more of: 1) regular reporting by meshed nodes to the current beacon broadcaster, 2) collecting neighbor lists by candidate beacon broadcasters, and 3) a short negotiation between a current beacon broadcaster and a candidate beacon broadcaster.

Reporting may be performed by all lightweight mesh point nodes associated with the current beacon broadcaster. As an example, regular reporting may occur at least once in three Delivery Traffic Indication Message (DTIM) intervals during Announcement Traffic Indication Message (ATIM) windows followed by DTIM beacons. In other words, the intervals may be set to optimally support mobility and applications. Since reporting by the meshed nodes may thus be reduced to a minimal amount, an effect of power consumption may be minimized. One example optimization may include only sending reports from the meshed nodes when the number of neighbors for a particular node changes. Another optimization may include not sending reporting messages when data is transmitted, in which case the data transmission may replace the reports.

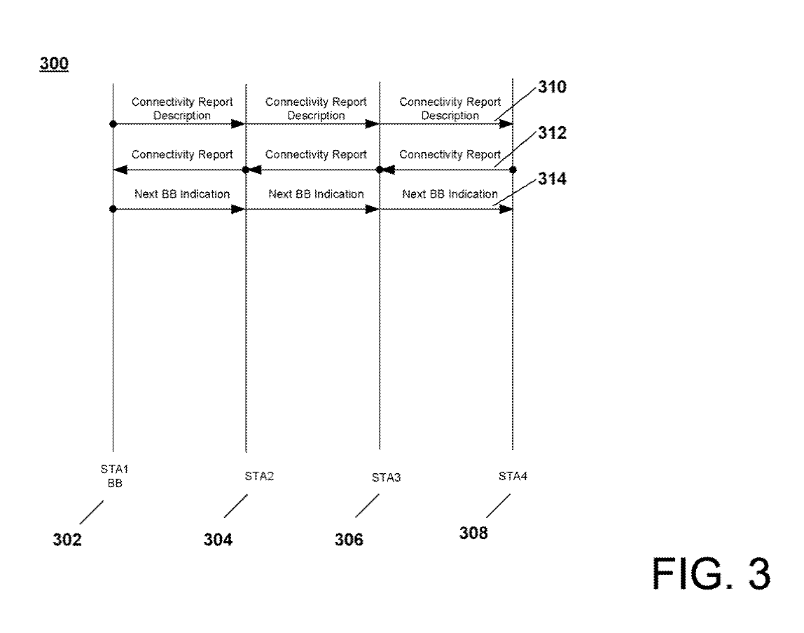

FIG. 3 is a diagram 300 illustrating operation of transmission of a report description from a current beacon broadcaster according to an example embodiment. As shown in FIG. 3, a meshed node STA1 302 may include a current beacon broadcaster for meshed nodes STA2 304, STA3 306, and STA4 308. The STA1 302 may send a connectivity report description 310 to the meshed nodes STA2 304, STA3 306, and STA4 308. The connectivity report description 310 may be sent, for example, via a beacon message, and may include, for example, information regarding the type of reporting information the STA1 302 may desire in order to determine a next beacon broadcaster for the meshed network that includes meshed nodes STA1 302, STA2 304, STA3 306, and STA4 308. Each of the meshed nodes STA2 304, STA3 306, and STA4 308 may then send a connectivity report 312 to the meshed node STA1 302 based on the connectivity report description 310.

The STA1 302 may then determine a next beacon broadcaster, based on the information included in the connectivity report 312 received from each of the meshed nodes STA2 304, STA3 306, and STA4 308, and may send a next beacon broadcaster indication 314 to the meshed nodes STA2 304, STA3 306, and STA4 308 to inform them of the next beacon broadcaster node.

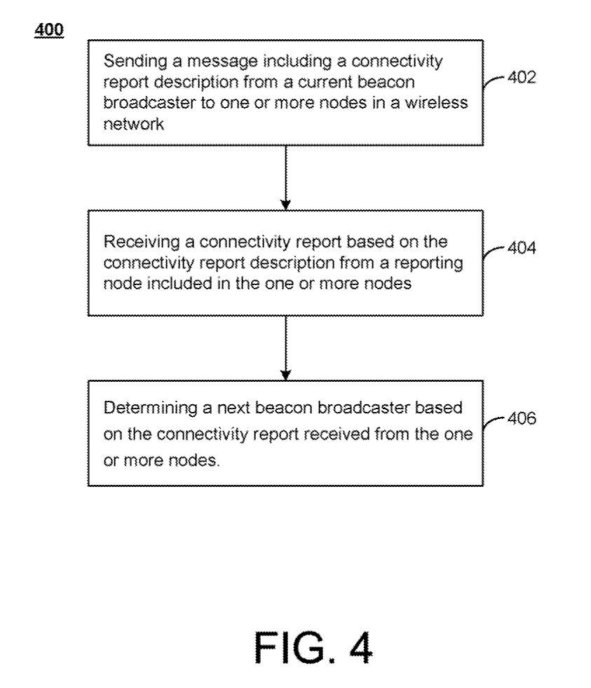

FIG. 4 is a flow chart 400 illustrating operation of determining a next beacon broadcaster according to an example embodiment. As discussed above, for example, a current beacon broadcaster may send a message including a connectivity report description from a current beacon broadcaster to one or more nodes in a wireless network (402). For example, the STA1 302 may send a message including the connectivity report description 310 to the meshed nodes STA2 304, STA3 306, and STA4 308.

The current beacon broadcaster may receive a connectivity report based on the connectivity report description from a reporting node included in the one or more nodes (404). For example, the STA1 302 may receive the connectivity report 312 from the meshed nodes STA2 304, STA3 306, and STA4 308. A next beacon broadcaster may be determined based on the connectivity report received from the one or more nodes (406). For example, the STA1 302 may determine a next beacon broadcaster based on the connectivity report 312 received from the meshed nodes STA2 304, STA3 306, and STA4 308. The current beacon broadcaster, for example, STA1 302, may then send a next beacon broadcaster indication to the meshed nodes, for example, the meshed nodes STA2 304, STA3 306, and STA4 308, to inform them of the next beacon broadcaster node.

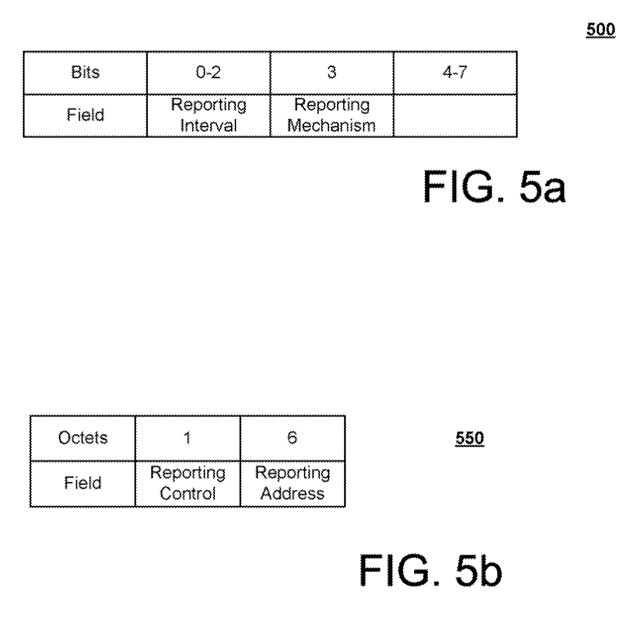

FIG. 5a is an example format of a reporting control field included in an example reporting information element field format according to an example embodiment. An example format that may be used for the connectivity report description 310 of FIG. 3 may include a reporting control field 500 that may be included in an information element field 550 (shown in FIG. 5b), which may, for example, be sent by a current beacon broadcaster node, for example, the meshed node STA1 302, via a beacon frame to the other meshed nodes, for example, the meshed nodes STA2 304, STA3 306, and STA4 308.

As shown in FIG. 5a, a reporting interval may include a three-bit value specifying, for example, an integer value for a connectivity reporting interval. As an example, lightweight meshed point nodes in an ad-hoc network may transmit reporting frames, specified by a reporting mechanism value, for example, between reporting interval DTIM beacons. In one example, if the reporting mechanism is set to a value of one, the lightweight meshed point nodes may send connectivity report frames, as discussed below, to distribute connectivity information in the network; however, if the reporting mechanism is set to a value of zero, the lightweight meshed point nodes may report via any reporting frame, including a frame with a null data portion.

FIG. 5b is an example reporting information element field format 550 according to an embodiment. The reporting information element of FIG. 5b may include a format for the reporting control field and a reporting address. The reporting address may specify an address where the reporting frames may be transmitted by the reporting nodes. If connectivity report frames are used to report connectivity, the reporting address may include a multicast address.

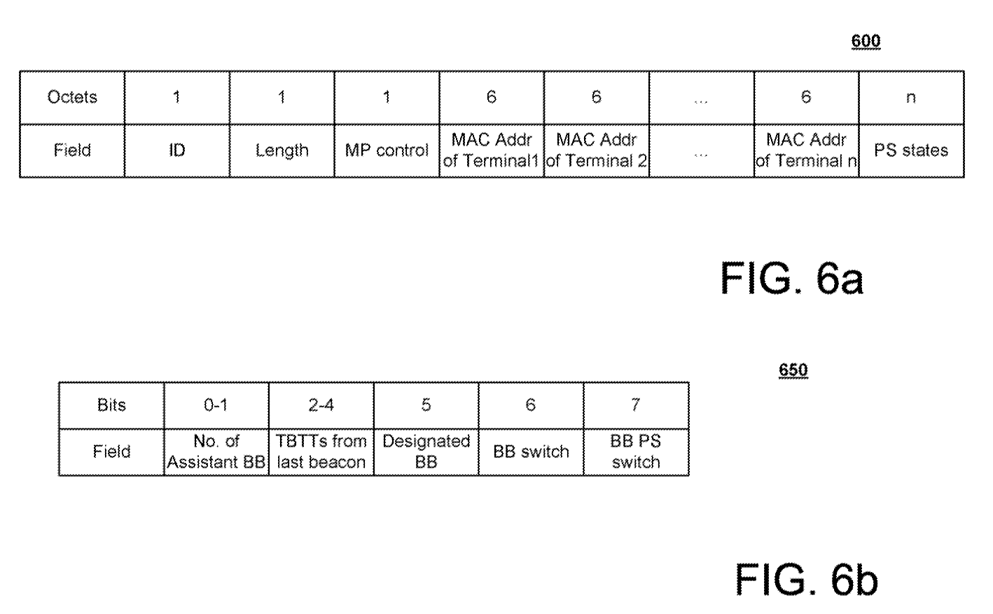

FIG. 6a is an example format of a neighbor list element 600 that includes an example meshed point control field format according to an example embodiment. FIG. 6 shows an example meshed point control field format 650. The neighbor list element may be transmitted by a meshed node to advertise the neighbor list of the meshed node, as well as the power save states of each of the neighbor nodes indicated by the neighbor list. As shown in the example of FIG. 6a, the neighbor list may include the MAC addresses of n nodes that are currently neighbors of the transmitting meshed node. When the neighbor list element may be transmitted with a connectivity report frame from the reporting meshed node, the MAC address of a network node is added to the neighbor list if the network node belongs to the same lightweight meshed node's network, and if a frame has been received, by the reporting node, from the network node within the last reporting interval.

The PS states field of the neighbor list element 600 may indicate a current power save state of each member of the neighbor list that is currently indicated in the neighbor list element 600. Thus, for example, if a bit is set to a value of 0, the corresponding member of the neighbor list may be in an awake state, and if the bit is set to a value of 1, then the corresponding member of the neighbor list may be in a power save state. For example, if the neighbor list element includes 8 MAC addresses and the PS states field includes a value of “00110001”, then the meshed nodes with MAC addresses included in positions 3, 4, and 8 in the neighbor list may be in a power save state.

The example meshed point control field format 650 may include a field indicating a number of Target Beacon Transmission Time (TBTT) intervals from the last received beacon frame from the Independent Basic Service Set (IBSS) that has a same random Basic Service Set ID (BSSID) value. For example, a value of zero for the field may indicate that a time less than or equal to the TBTT has elapsed since a beacon was last received by the transmitting node, and a value of 7 may indicate that a time greater than or equal to 7 or more TBTT intervals has elapsed since a beacon was last received by the transmitting node.

A “number of assistant beacon broadcasters” field may indicate that 0-3 assistant beacon broadcasters may be introduced in the network. Any nodes that may be selected to perform as assistant beacon broadcasters may be communicated to network nodes via the neighbor list. For example, the first entry in the neighbor list may indicate the MAC address of the selected main beacon broadcaster, and if the “number of assistant beacon broadcasters” field is non-zero, the next 1-3 entries in the neighbor list may indicate the MAC address(es) of any selected assistant beacon broadcaster nodes.

A beacon broadcaster (BB) switch field may indicate a switch to a new beacon broadcaster node. If the BB switch field included with a DTIM frame is set to a value of 1, the next beacon may be sent by the meshed node indicated by the first MAC address in the neighbor list of the neighbor list element 600.

A BB PS state may indicate whether a current beacon broadcaster is using power save mode. For example, if the BB PS state bit is set to a value of 1, then the beacon broadcaster may send only DTIM frames to accommodate the power save mode of all receiving nodes and the beacon broadcaster. However, if the BB PS state bit is set to a value of 0, then the beacon broadcaster may be continuously awake.

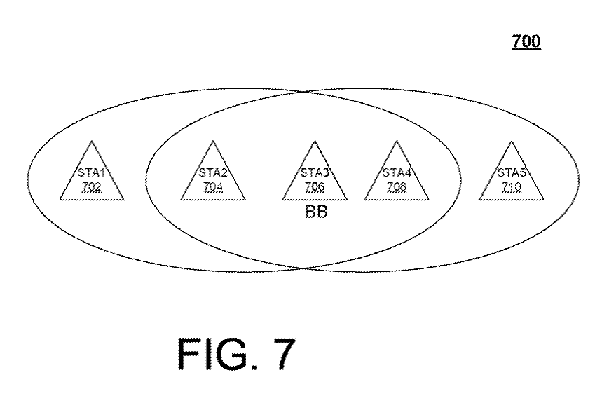

FIG. 7 is a diagram of an example configuration of a wireless meshed network 700 according to an embodiment. In the example configuration shown in FIG. 7, network nodes STA1 702, STA2 704, STA3 706, STA4 708, and STA5 710 are shown such that the STA3 706, acting as the current beacon broadcaster node, can send messages to each of the other network nodes STA1 702, STA2 704, STA4 708, and STA5 710, and such that each of the other network nodes STA1 702, STA2 704, STA4 708, and STA5 710 are covered by the STA3 706 beacon broadcaster. Additionally, each of the network nodes STA2 704 and STA4 708 may send messages to all the other network nodes shown in FIG. 7, while STA1 702 may not reach STA5 710, and STA5 710 may not reach STA1 702. Thus, neither of STA1 702 nor STA5 710 would appear to be a good candidate for a next beacon broadcaster, while both of STA2 704 and STA4 708 appear to be optimal candidates for a next beacon broadcaster, as each is able to reach all other nodes in the network as shown.

One purpose of switching the role of beacon broadcaster may be to balance power consumption among devices represented by meshed network nodes. Example reasons for selecting particular network nodes as the next beacon broadcaster, and for not selecting other network nodes, include avoiding breaking the connectivity of the network and avoiding switching the role of beacon broadcaster to network nodes that may be unfavorably located, for example, as STA1 702 and STA5 710 of FIG. 7 may not be able to send beacons to all other network nodes. A selection of a next beacon broadcaster node may not be a trivial problem when one or more network nodes no longer receive messages, for example, beacons, from the current beacon broadcaster, and/or some network nodes still receive messages from the current beacon broadcaster, and other network nodes do not receive messages from the current beacon broadcaster. Moreover, the selection process may be difficult if one or more network nodes is receiving messages from more than one beacon broadcaster. An exemplary selection mechanism described herein may be based on the connectivity reports received by the current beacon broadcaster from the current network nodes.

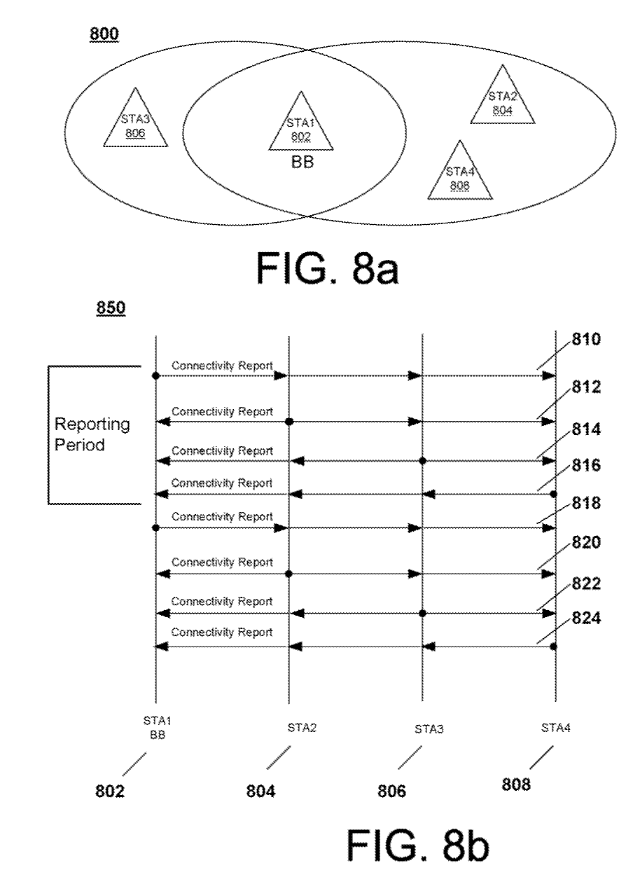

FIG. 8a is a diagram of an example configuration of a wireless meshed network 800 according to an embodiment. In the example configuration shown in FIG. 8a, network nodes STA1 802, STA2 804, STA3 806, and STA4 808 are shown such that the STA1 802, acting as the current beacon broadcaster node, can send messages to each of the other network nodes STA3 806, STA2 804, and STA4 808, and such that each of the other network nodes STA3 806, STA2 804, and STA4 808 are covered by the STA1 802 beacon broadcaster.

FIG. 8b is a diagram illustrating operation of transmission of reports from wireless meshed nodes according to an example embodiment. As shown, each of network nodes STA1 802, STA2 804, STA3 806, and STA4 808 may send multicast connectivity reports, for example, during a DTIM ATIM period, so that each network node is awake to receive the report. A connectivity report is used to share information from each network node regarding beacons and transmissions received from other network nodes that have been received by the transmitting network node, and all network nodes may send connectivity reports. A beacon broadcaster may change the connectivity reporting periodicity, based on the mobility and connectivity of the network nodes, for example, when the beacon broadcaster sends a connectivity report description to reporting nodes as discussed with regard to FIG. 3. The reporting nodes may transmit the connectivity reports infrequently to avoid congestion during the ATIM periods, and to avoid long ATIM periods.

As shown in FIG. 8b, the network node STA1 802, acting as the current beacon broadcaster, may send a connectivity report 810 as a multicast message to STA2 804, STA3 806, and STA4 808. As discussed previously, the connectivity report message 810 may include a neighbor list indicating the network nodes that are neighbors to the transmitting node, as well as information regarding each neighbor node and the transmitting node so that each receiving node may have the information available to share with other receiving network nodes. Further, each of the network nodes STA2 804, STA3 806, and STA4 808 may transmit connectivity reports 812, 814, 816 respectively as multicast messages to the other network nodes during the reporting period. Each of the network nodes STA1 802, STA2 804, STA3 806, and STA4 808 may then send multicast connectivity reports 818, 820, 822, 824 respectively to each of the other network nodes during a next reporting period. Each of the receiving network nodes may then keep track of which network nodes are successfully sending messages to the respective receiving node, and may include such information in the connectivity report sent by the respective node.

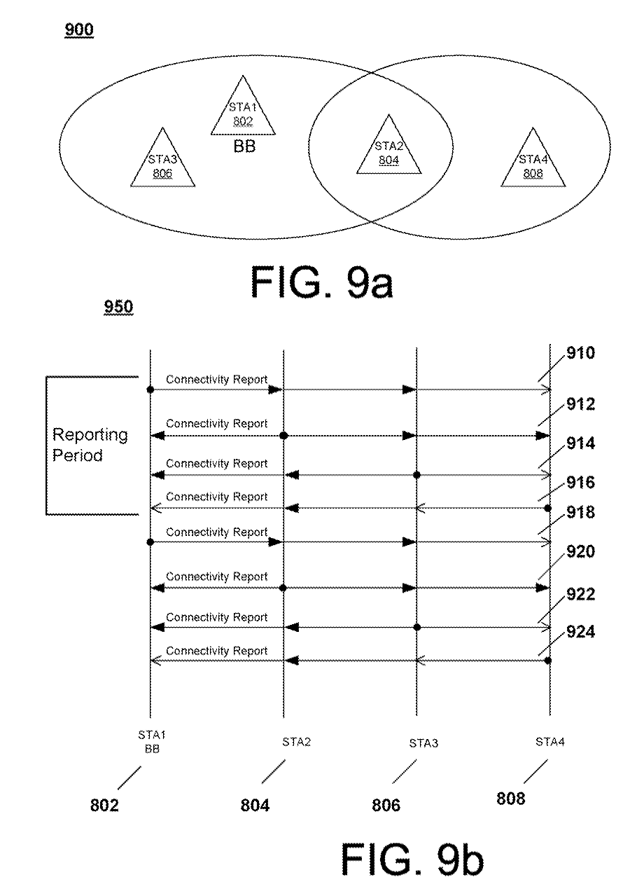

FIG. 9a is a diagram of an example configuration of a wireless meshed network 900 according to an embodiment. In the example configuration shown in FIG. 9a, network nodes STA1 802, STA2 804, STA3 806, and STA4 808 are shown such that the STA1 802, acting as the current beacon broadcaster node, can send messages to each of the other network nodes STA2 804 and STA3 806, but STA4 808 is unable to receive messages from the beacon broadcaster STA1 802 and from the network node STA3 806. Conversely, STA4 808 is unable to send messages to STA1 802 and STA3 806. However, STA2 804 may send messages to, and receive messages from, all of STA1 802, STA3 806, and STA4 808

FIG. 9b is a diagram illustrating operation of transmission of reports from wireless meshed nodes according to an example embodiment. As shown, each of network nodes STA1 802, STA2 804, STA3 806, and STA4 808 may send connectivity reports to each of the other network nodes. However, STA1 802, acting as the current beacon broadcaster, may send a connectivity report 910 to the network nodes STA2 804, STA3 806, and STA4 808, and STA4 808 may not receive the connectivity report 910. STA2 804 may send a connectivity report 912 to each of the other network nodes, which may be received by each of the other nodes. STA3 806 may send a connectivity report 914 which may be received by STA1 802 and STA2 804, but not by STA4 808. STA4 808 may send a connectivity report 916 which may be received by STA2 804, but not by STA1 802 and STA3 806. Similarly, connectivity reports 918, 920, 922, and 924 may be sent in a next reporting period. However, since each network node may receive information regarding all other network nodes via the connectivity reports from other network nodes, the current beacon broadcaster STA1 802 may determine, for example, that STA4 808 is currently not able to send messages to, or receive messages from, STA1 802 and STA3 804, and may select STA2 804 as a next beacon broadcaster, based on received connectivity reports.

As shown in FIG. 9b, each network node may receive a connectivity report from at least one other network node, even though the receiving network node may not be receiving beacon messages from the current beacon broadcaster STA1 802. Thus, the connectivity reports may act as beacon frames in support of network connectivity, as the receiving network node may remain connected/synchronized based on the received connectivity reports. Thus, the network nodes that receive the connectivity reports may not need to attempt to send a beacon message immediately upon discovery that the receiving node may not be receiving any beacon messages. Further, in order to maximize a connectivity time for the nodes receiving the connectivity reports but not receiving any beacons, for example, as a result of selecting a non-optimal beacon broadcaster, it may be possible to implement a time-out for a period of time that is longer than a period of time that one network node maintains a role of beacon broadcaster, to allow such receiving nodes to maintain connectivity without a need to quickly start competing for a beacon opportunity.

Further, as an example recovery mechanism, a network node may receive connectivity reports from other network nodes and may determine that none of the nodes sending the reports has received a beacon, for example, within the last 3 DTIM beacon intervals. Further, if a connectivity reporting interval has elapsed since any beacon was received by any of the network nodes sending the received reports, it may be possible to determine a network node having a greatest amount of connectivity, for example, by analysis of a node's neighbor list. The node so determined may then begin to compete on a next beacon transmission opportunity.

As another example of a recovery mechanism, if the network node receiving the connectivity reports from other network nodes determines that the receiving node has not received a beacon for at least 5 DTIM beacon intervals, and that none of the nodes sending the received reports has received a beacon, for example, within the last 2 DTIM beacon intervals, it may be determined that the nodes may begin to compete on a next beacon transmission opportunity.

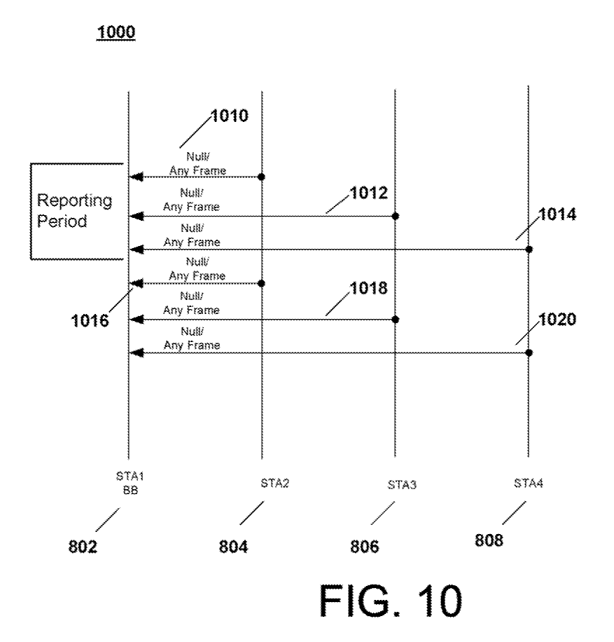

FIG. 10 is a diagram illustrating operation of unicast transmission of reports from wireless meshed nodes according to an example embodiment. Transmitting network nodes may thus transmit any type of frame to a current beacon broadcaster node to indicate that the transmitting node is available on the network, with no need to maintain any connectivity information regarding other network nodes at the transmitting node. Thus, each reporting node may send a message, for example, that includes a MAC header and a null message body. Thus, as shown in FIG. 10, each of STA2 804, STA3 806, and STA4 808 may send a unicast message as any message, or a message including a null body as messages 1010, 1012, 1014, respectively, to the current beacon broadcaster node STA1 802. Optionally, the STA1 802 may send an acknowledgment message to each of STA2 804, STA3 806, and STA4 808 to acknowledge receipt of the messages 1010, 1012, 1014. In this manner, the beacon broadcaster, for example, STA1 802, may assume the responsibility for maintaining information regarding all network nodes that can send messages to the beacon broadcaster, and STA1 802 may maintain its own neighbor list, without receiving neighbor lists from reporting nodes. The network nodes STA2 804, STA3 806, and STA4 808 may send unicast reporting messages 1016, 1018, and 1020 to STA1 802 in the next reporting period.

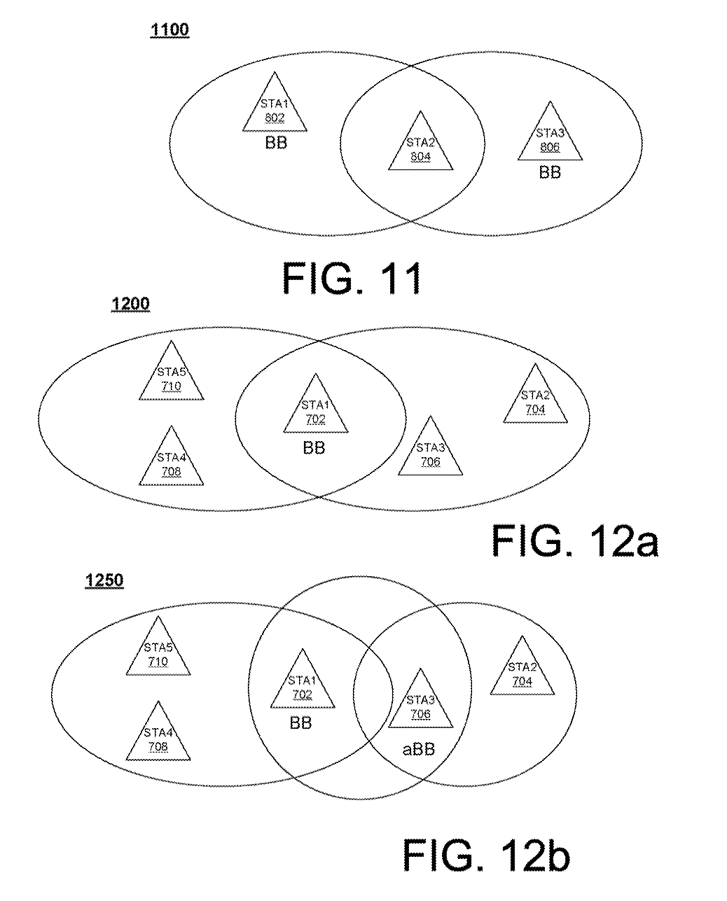

FIG. 11 is a diagram of an example configuration of a wireless meshed network including a node receiving beacon messages from two beacon broadcaster nodes according to an embodiment. As shown in FIG. 11, a network node STA2 804 may receive beacon messages from a first beacon broadcaster STA1 802 included in a first network, and from a second beacon broadcaster STA3 806 included in a second network. Different network identifiers may be used by the different beacon broadcasters, as well as different connectivity reporting descriptions for reporting connectivity to the separate beacon broadcasters. The connectivity report sent by STA2 804 to each of the beacon broadcasters may thus include neighbor lists indicating the network node neighbors of STA2 804, as well as information obtained from connectivity reports received by STA2 804 from other reporting nodes for both networks. Access to more than one beacon broadcaster may occur, for example, when nodes move from one place to another. Beacon timing reporting may be used to avoid collisions in transmissions from STA2 804.

As more information regarding nodes that send information to STA2 804 may become available to both STA1 802 and STA3 806, as well as to the network nodes receiving beacons and connectivity information from STA1 802 and STA3 806, a better network connectivity may result from the sharing of the information. However, a potential disadvantage of allowing STA2 804 to communicate with more than one beacon broadcaster may include more power consumption as part of the overhead of communicating with multiple beacon broadcasters.

FIG. 12a is a diagram of an example configuration of a wireless meshed network 1200 including a single beacon broadcaster according to an embodiment. In the example configuration shown in FIG. 12, network nodes STA1 702, STA2 704, STA3 706, STA4 708, and STA5 710 are shown such that the STA1 702, acting as the current beacon broadcaster node, can send messages to each of the other network nodes STA2 704, STA3 706, STA4 708, and STA5 710, and such that each of the other network nodes STA2 704, STA3 706, STA4 708, and STA5 710 are covered by the STA1 702 beacon broadcaster. Movement of devices included in the network may, however lead to a situation wherein STA2 704 may no longer be able to receive beacons from the current beacon broadcaster STA1 702. It may be possible at that time for STA2 704 to begin sending beacons, and to establish a new ad hoc network with STA2 704 as the beacon broadcaster. However, this may lead to fragmented networks, with a large number of beacon broadcasters and few listening non-beacon broadcaster nodes. To alleviate this possibility, the current beacon broadcaster node STA1 702 may be configured to determine one or more assistant beacon broadcaster nodes to assist with beaconing activities.

FIG. 12b is a diagram of an example configuration of a wireless meshed network 1250 including an assistant beacon broadcaster according to an embodiment. In the example configuration shown in FIG. 12, network nodes STA1 702, STA2 704, STA3 706, STA4 708, and STA5 710 are shown such that the STA1 702, acting as the current beacon broadcaster node, can send messages to each of the other network nodes STA3 706, STA4 708, and STA5 710; however, STA2 704 is no longer able to receive messages from STA1 702. Therefore, in this example, the current beacon broadcaster STA1 702 may determine, based on connectivity information, that STA3 706 has connectivity that may produce good communication for sending beacons, at least to STA2 704, and thus STA1 702 may select STA3 706 as an assistant beacon broadcaster. Alternatively, STA3 706 may receive a message from STA2 704 indicating that STA2 704 is not receiving messages, for example, beacons, from the current beacon broadcaster STA1 702, and STA3 706 may assume the role of assistant beacon broadcaster, for example, if STA3 706 is the first neighbor node indicated by the neighbor list of STA2 704, which may be received by STA3 706 via connectivity reports sent by STA2 704. This type of connectivity information may also be sent to STA1 702 at least by STA3 706. Reporting to the assistant beacon broadcaster STA3 706 may be accomplished via broadcast messages sent to all nodes in the network, or via unicast messages, which may be sent, for example, to nodes that may be indicated as highest ranking nodes on the neighbor list last received from the current beacon broadcaster.

Assistant beacon broadcasters may transmit both a beacon and a connectivity report. Using the connectivity report, the main beacon broadcaster may be informed about the nodes reporting to the assistant beacon broadcasters, which enables the main beacon broadcaster to make appropriate decisions about beacon broadcaster rotation. The main beacon broadcaster knows how many assistant beacon broadcasters exist in the network, and the main beacon broadcaster may set appropriate medium reservations for transmission of all beacons, e.g., Network Allocation Vector (NAV) setting. The beacons of the main and assistant beacon broadcasters may be transmitted in order. Thus, the main beacon broadcaster may transmit, and then the assistant beacon broadcasters may transmit in order according to an ordering of the nodes indicated by the neighbor list maintained by the main beacon broadcaster. Thus, upon receiving of a beacon, the assistant beacon broadcasters may forward the beacon, for example, according to the following formula:

position_in_neighbor_list*(time-out+beacon transmission time)

The position in the neighbor list, as used in the formula, refers to the position in the list issued by the beacon broadcaster at the time of rotation. The time-out may be, for example, a point inter-frame space (PIFS), or a short inter-frame space (SIFS).

The role of assistant beacon broadcaster assumed by STA3 706 may be relinquished by STA3 706 if STA2 704 no longer sends messages to STA3 706, or if it is determined that STA2 704 may be able once more to receive beacons from the current beacon broadcaster STA1 702. Moreover, STA3 706 may relinquish the role of assistant beacon broadcaster if the beacon broadcaster role is switched from STA1 702 to another network node.

Thus, in one aspect, a report sent from the reporting nodes may include a null packet, or, any other transmission which the current beacon broadcaster may expect to receive may also be understood as a report, as discussed with regard to FIG. 10. If a null packet or any other traffic that is transmitted during an ATIM period is implemented for a connectivity report, then the reporting meshed nodes may only report themselves, only to the current beacon broadcaster, and the current beacon broadcaster may track the number of nodes in the Independent Basic Service Set (IBSS) through the report messages.

In another aspect, a connectivity report frame may be specified that may include information regarding a number of neighbors from which the reporting node receives messages as discussed with regard to FIG. 6. Additionally, the connectivity report frame may include any medium access control (MAC) addresses that are listed in the current beacon broadcaster's beacon frame, but from which the transmitter of the connectivity report has not received any frames for some predetermined period of time, e.g. for three DTIM periods. The connectivity report may also include information regarding a time when a last beacon frame was received, as well as a MAC address of the node of the last received beacon frame. The connectivity reports may be transmitted to a specific multicast address, and may include information regarding the number of connectivity reports that the reporting node has received from other meshed nodes. The current beacon broadcaster may include this information in a beacon frame sent to the meshed nodes to indicate the network connectivity.

The connectivity report messages may also include information regarding battery status, applications used by a reporting node, and some node-specific name information to provide more detailed information regarding available meshed nodes as discussed with regard to FIG. 6.

For meshed nodes that may be receiving messages from two or more beacon broadcasters, each of which may not receive messages from the other, a different reporting process for the beacon broadcasters may be implemented. For example, the reporting node may report to only one beacon broadcaster, if the reporting node is more associated with certain devices. From a perspective of a reporting node, it may be more power efficient to report to only one beacon broadcaster, and it may be less complex to synchronize with only one beacon broadcaster. However, reporting to multiple beacon broadcasters may yield better connectivity between the nodes in the network as discussed with regard to FIG. 11.

If a reporting node reports to multiple beacon broadcasters, the reports or other transmissions may not overlap with any beacon broadcaster's beacons. As an example, a beacon broadcaster may specify a multicast address that may be used to send connectivity reports by the meshed nodes in an IBSS network. If a reporting node belongs to several IBSS networks, it may transmit connectivity reports to all networks to which it belongs. A new IBSS network may randomly select a multicast address that is not used in the network area.

A current beacon broadcaster may update a neighbor list in its beacons according to the reports or other indications from the neighbors.

Before selecting a new beacon broadcaster, the current beacon broadcaster may obtain information regarding candidate beacon broadcasters, such as 1) power save support; 2) beacon broadcaster role support; 3) a number of network nodes from which the candidate beacon broadcaster has received messages; 4) a similarity of the neighborhood of the candidate beacon broadcaster node to the neighborhood of the current beacon broadcaster; 5) connectivity of the candidate beacon broadcaster to a gateway, authentication servers, management servers, etc.; and/or 6) battery level of the candidate beacon broadcaster node. The current beacon broadcaster may then select an optimal candidate to become a new beacon broadcaster node based on the obtained information. The current beacon broadcaster may indicate an ordering of optimality of the candidates via an ordering of the neighbor list of neighbor network nodes maintained by the current beacon broadcaster, which may be shared with other network nodes, for example, via beacon messages including connectivity reports.

The current beacon broadcaster may further consider applications used by the candidate beacon broadcasters and the network topology in selecting a best candidate for becoming a new beacon broadcaster node. Moreover, the number of beacon broadcasters in the network may be minimized by selecting a candidate that is not located on the edge of the network. If the selection criteria are not met, the current beacon broadcaster may decide not to switch the role of beacon broadcaster to a different network node.

When a network node determines that it may be the selected new beacon broadcaster, for example, the network node determines that it has been placed at the head, or top, of the current beacon broadcaster's neighbor list, the network node may begin preparing for the switch. Thus, for example, the network node may begin to collect its own neighbor list. For a network with mobile devices or network nodes, the update of the network node's neighbor list may occur within a small number of DTIMs before the switch, as the network node will need an updated neighbor list to serve well in the role of beacon broadcaster after the switch.

The candidate beacon broadcaster may send its current neighbor list to the current beacon broadcaster before the switch, so that the current beacon broadcaster may ensure that the candidate beacon broadcaster satisfies network topology constraints considered by the current beacon broadcaster in selecting the new beacon broadcaster. For example, the current beacon broadcaster may determine whether the candidate beacon broadcaster may be currently located on the edge of the network, or the neighbor list of the candidate beacon broadcaster may include nodes that are substantially different from nodes in the neighbor list of the current beacon broadcaster. It may be desirable for the candidate beacon broadcaster's neighbor list to be delivered to the current beacon broadcaster close to the expected switch of the beacon broadcaster role, for example, to increase a reliability, or freshness, of the neighbor list.

If the reporting nodes do not receive the current beacon broadcaster's beacon, the reporting nodes may continue to transmit connectivity report frames to the ad hoc network, with a predetermined multicast address. If a reporting node receives a beacon, for example, after an original Target Beacon Transmission Time (TBTT), or a time instant at which the node has scheduled a next beacon message, the reporting node may return to the normal beacon period operation and stop its own beacon transmission.

Conventionally, a beacon broadcaster may schedule the transmission of a beacon frame every beacon interval, for example, every 102.4 ms, and a time instant at which beacon broadcaster schedules a next beacon message may be referred to as a Target Beacon Transmission Time (TBTT). Thus, time zero may be defined to be a TBTT. Given a value of a beacon interval, an end-host may determine exact time instants when beacon messages are scheduled for transmission. For example, a time difference between the instant when a beacon message transmission begins, as may be obtained from a timestamp field of a beacon frame, and the TBTT, may yield an estimate of a beacon delay, which may be determined as the total time spent by a beacon frame at the beacon broadcaster waiting for transmission.

If a meshed node is transmitting data with another meshed node, and neither meshed node receives beacon frames, the meshed nodes may continue the data transmission normally. If the meshed nodes have set a stream between each other, the stream may continue, for example, until a maximum number of consecutive erased frames is met, for example, until three erased frames are received. If this number is met, the data exchanging meshed nodes may re-perform the ATIM signaling and reset the stream.

If two meshed nodes that have ongoing data transmission receive connectivity reports from each other indicating that both nodes have not received a beacon from the current beacon broadcaster, for example, in the most recent 5 DTIM intervals, the nodes may continue the data transmissions and may either use distributed beacon broadcaster functionality or they may generate their own ad hoc network and begin transmitting beacons for their network, for example, according to rules described below.

Depending on the connectivity status of the nodes, different recovery mechanisms may be applied. If a connection still exists, a distributed approach may be implemented wherein the beacon broadcaster functionality is distributed over multiple nodes, thus maintaining network connectivity. If network connectivity has been lost, for example, nodes having a larger number of neighbor nodes may be prioritized in establishing a new network, if a minimal number of beacon broadcasters may yield network connectivity according to such a scheme.

A current beacon broadcaster may, for example, transmit a notification to network nodes from which messages have not been received by the new beacon broadcaster. The notification message may inform the network nodes that they may not be receiving beacon frames from the new beacon transmitter. The notification message may, for example, specify a recovery mechanism to be implemented to utilize a distributed beacon broadcaster functionality or to utilize a prioritized beacon broadcaster functionality.

Depending on the topology of the network it may be possible to switch the function of beacon broadcaster to a single node that may be connected to the same set of nodes as the current beacon broadcaster. However, if it is not possible to determine such a node that covers the same set of nodes, it may be desirable, for example, to switch the function of beacon broadcaster to multiple nodes, so that the network connectivity is maintained. One of the new beacon broadcasters may be referred to as the “main beacon broadcaster,” with the other beacon broadcasters referred to as “assistant beacon broadcasters,” as discussed with regard to FIGS. 6a and 6b.

The main beacon broadcaster may be responsible for coordinating the network, and for selecting the next beacon broadcaster. The assistant beacon broadcasters may, for example, be responsible for continuation of the beaconing and for reporting to the main beacon broadcaster information regarding the nodes they currently serve. The new beacon broadcasters may transmit beacons periodically, consistent with existing beacon settings.

The beacon broadcaster switch to more than one node may be indicated by use of multiple beacon broadcaster switch bits. For example, in the example meshed node control field 650 shown in FIG. 6b, two or more bits may be reserved to indicate a number X of beacon broadcasters to which the role of beacon broadcaster may be switched. The beacon broadcaster switch may, for example, be performed on the first X entries in the neighbor list, as specified in the beacon broadcaster switch field. As discussed with regard to FIG. 6a, the first entry in the neighbor list may indicate the main beacon broadcaster, with the remaining entries, up to the value of X, indicating assistant beacon broadcasters.

Main and assistant beacon broadcasters may transmit their beacons in a non-colliding manner. One option for the beacon transmissions, for example, may include alternating beacon transmission times based on a predetermined schedule that has been agreed upon in advance of the beacon broadcaster switch. Alternatively, the beacon broadcasters, i.e., the main and assistant beacon broadcasters, may transmit their respective beacons in sequence after one another. For example, the main beacon broadcaster may transmit its beacon at TBTT and the assistant beacon broadcaster may transmit its beacon at TBTT+offset, where the offset, for example, may be smaller than an ATIM window. As another alternative, for example, a backoff algorithm may be implemented to manage the timing of the transmitted beacons of the main beacon broadcaster and any assistant beacon broadcasters.

The assistant beacon broadcasters may inform a main, or parent, beacon broadcaster of their neighbors, for example, via a neighbor list element included in their respective beacons, so that the main beacon broadcaster may obtain an overview of the current nodes in the network. For example, a neighbor list element as discussed with regard to FIG. 6a may be included in their respective beacons.

The scheme discussed above may avoid splitting an existing network into two or more networks. As it may be preferable to avoid splitting the beacon broadcaster functions, a main beacon broadcaster may preferably select only one node to assume the beacon broadcaster role, and may only split the beacon broadcaster role if no network node is available that has a sufficiently large coverage area to assume a sole beacon broadcaster role.

An appropriate beacon broadcaster may be selected based on the connectivity reports sent by the various reporting nodes. The connectivity reports may provide the current beacon broadcaster with an overview of its second hop neighbors, which may further provide an opportunity to ensure maximal spatial topological separation between a main beacon broadcaster and an assistant beacon broadcaster.

If the beacon broadcaster functionality is not split, some nodes may not be covered by the new beacon broadcaster after a switch of beacon broadcaster functionality. Those nodes that are not within range of the new beacon broadcaster may thus initiate a new network. Nodes with more neighbors may be assigned a priority in initializing a new network and in assuming the role of beacon broadcaster, which may be ensured by implementing a time-out. Such a time-out may be implemented as a function of the number of neighbors of a respective node. As examples, two different time-out mechanisms may be implemented as 1) starting the beacon transmission after a smaller number of DTIM intervals, or 2) implementing a shorter backoff in channel access for the beacon frame.

Lightweight meshed nodes that have multiple neighbors may begin obtaining Transmission Opportunities (TXOPs) for beacons earlier than lightweight meshed nodes that receive messages from comparatively fewer network nodes, thus increasing a probability that a lightweight meshed node may be determined that may be associated with a largest number of lightweight meshed nodes that receive the transmissions of the selected node. An example algorithm for determining a waiting interval before the determined node begins transmission of a beacon may be expressed as follows:
Begin transmission of a beacon after 4 consecutive DTIM intervals without receiving a beacon, if a number of network nodes from which a signal has been received by the respective node is equal to or is greater than the number of network nodes from which a signal has been received by the previous beacon broadcaster, or if the number of network nodes from which a signal has been received by the respective node is second in magnitude, among all network nodes, to the number of network nodes from which a signal has been received by the previous beacon broadcaster;
else begin transmission of a beacon after 5 consecutive DTIM intervals without receiving a beacon.

Network nodes that do not receive beacons from the new beacon broadcaster may begin transmission of beacon messages, for example, after waiting a time period such as a

SafeTimeFromMainBeacon+TimeOut

wherein the SafeTimeFromMainBeacon may be implemented as a predetermined waiting interval, and the TimeOut value may represent an additional time-out which may, for example, be implemented as a function of the number of neighbor nodes of the respective node that does not receive a beacon. An example criterion for the function may include a property that it is inversely proportional to the number of neighbor nodes of the respective node, i.e., the time-out may be shorter if the number of neighbor nodes is comparably larger, such that nodes with a large number of neighbor nodes may establish a new network faster than nodes with a comparatively smaller number of neighbor nodes. Thus, fragmentation of the existing networks may be minimized.

A potential equation for calculating the additional time-out may be formulated as follows:

Max{CWmin[AC==3]−Number_of_Neighbors, 1}*aSlot

Additionally, randomization, or a hash function may be used to prevent colliding initialization of new networks in case some nodes have an equal number of neighbors.

New networks may continue to listen to the old ATIM windows so that they can re-synchronize and rejoin the old network when desired, even though they may have determined a different DTIM for use in their respective new network.

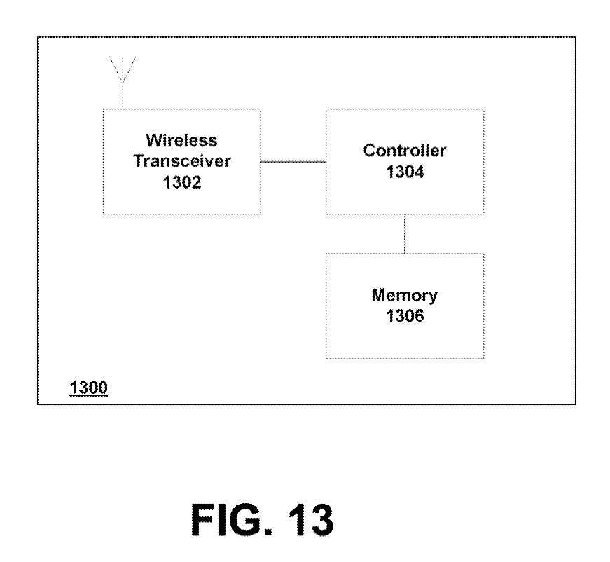

FIG. 13 is a block diagram illustrating an apparatus 1300 that may be provided in a wireless station according to an example embodiment. The wireless station may include, for example, a wireless transceiver 1302 to transmit and receive signals, a controller 1304 to control operation of the station and execute instructions or software, and a memory 1306 to store data and/or instructions. Controller 1304 may be programmable, and capable of executing software or other instructions stored in memory or on other computer media to perform the various tasks and functions described above. In addition, a storage medium may be provided that includes stored instructions, that when executed by a controller or processor, may result in the controller 1304 performing one or more of the functions or tasks described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method comprising:
sending a message including a connectivity report description from a current beacon broadcaster to one or more nodes in a wireless network; and
receiving a connectivity report based on the connectivity report description from a reporting node included in the one or more nodes; and
determining a next beacon broadcaster based on the connectivity report received from the one or more nodes.

2. The method of claim 1 wherein:
the sending the message including the connectivity report description comprises sending from the current beacon broadcaster to the one or more nodes a beacon message including a reporting information element.

3. The method of claim 2 wherein:
the reporting information element includes a reporting control field and a reporting address field.

4. The method of claim 3 wherein:
the reporting address field indicates a unicast, multicast, or broadcast reporting address.

5. The method of claim 3 wherein:
the reporting control field includes a reporting mode field and a reporting interval field.

6. The method of claim 5 wherein:
the reporting mode field indicates one of a plurality of reporting modes including a first mode wherein nodes are requested to send a first mode message in response to the beacon message and a second mode wherein nodes are requested to send a second mode message in response to the beacon message, the second mode message including a neighbor list identifying other nodes for which the reporting node has received messages.

7. The method of claim 5 wherein:
the reporting interval field indicates a period between connectivity reports.

8. The method of claim 1 wherein:
the receiving the connectivity report comprises receiving, from each of the one or more nodes, a connectivity report including a neighbor list identifying neighbor nodes with respect to the reporting node.

9. The method of claim 1 wherein:
the determining the next beacon broadcaster comprises determining the next beacon broadcaster based on one or more of support for a beacon broadcaster role for the reporting node, a battery level for the reporting node, a power save support for the reporting node, a neighbor list identifying other nodes in the wireless network from which the reporting node has received messages, a number of wireless nodes identified in the neighbor list from the reporting node, or a connectivity of the reporting node to a gateway, to an authentication server, or to other management servers.

10. The method of claim 1 and further comprising:
sending a message identifying the next beacon broadcaster to the one or more nodes in the wireless network.

11. The method of claim 1 and further comprising:
receiving a list of indicators of neighbor nodes from the next beacon broadcaster; and
determining a range of transmission of the next beacon broadcaster based on the received list of indicators of neighbor nodes received from the next beacon broadcaster.

12. The method of claim 1 and further comprising:
receiving a notification message from one of the wireless nodes in the network notifying the current beacon broadcaster that one of the nodes is unable to receive messages from the next beacon broadcaster; and
determining a revised next beacon broadcaster based on the notification message received from the wireless node.

13. The method of claim 1 and further comprising:
determining an assistant beacon broadcaster based on the connectivity report received from the one or more nodes.

14. The method of claim 1 and further comprising:
determining that one or more nodes in the wireless network are unable to receive messages from the next beacon broadcaster; and
determining an assistant beacon broadcaster to broadcast a beacon for the nodes that are unable to receive the messages from the next beacon broadcaster.

15. The method of claim 1 and further comprising:
switching a role of beacon broadcaster from the current beacon broadcaster to the next beacon broadcaster.

16. The method of claim 15 wherein:
the switching the role of beacon broadcaster comprises transmitting a message to the one or more nodes in the wireless network identifying the next beacon broadcaster.

17. The method of claim 15 wherein:
the switching the role of beacon broadcaster from the current beacon broadcaster to the next beacon broadcaster comprises transmitting a beacon message including a neighbor list, the neighbor list identifying the next beacon broadcaster as a predetermined entry in the neighbor list.

18. A method comprising:
receiving a message including a connectivity report description from a current beacon broadcaster;
sending a connectivity report to the current beacon broadcaster based on the received connectivity report description; and
receiving a message identifying the next beacon broadcaster from the current beacon broadcaster.

19. The method of claim 18 and further comprising:
determining a number of transmission intervals for which no beacon message is received by the one wireless node; and
initiating a broadcast of a beacon message to the other nodes included in the plurality of nodes of the wireless network if the number of transmission intervals exceeds a predetermined threshold value.

20. The method of claim 18 and further comprising:
switching a role of beacon broadcaster from the current beacon broadcaster to the next beacon broadcaster.

21. An apparatus for wireless communications, the apparatus comprising:
a controller;
a memory coupled to the controller; and
a wireless transceiver coupled to the controller;
the apparatus adapted to:
send a message including a connectivity report description from a current beacon broadcaster to one or more nodes in a wireless network;
receive a connectivity report based on the connectivity report description from a reporting node included in the one or more nodes; and
determine a next beacon broadcaster based on the connectivity report received from the one or more nodes.
